(19) United States
(12) Patent Application Publication
(10) Pub. No.: US 2025/0200098 A1
(43) Pub. Date: Jun. 19, 2025

(54) SYSTEMS AND METHODS RELATING TO MINING CONVERSATION FLOWS

(71) Applicant: Genesys Cloud Services, Inc., Menlo Park, CA (US)

(72) Inventors: Sanjeev Halyal, Galway (IE); Prasanth Balaraman, Galway (IE); Canice Lambe, Galway (IE); Emir Munoz, Galway (IE)

(21) Appl. No.: 18/987,354

(22) Filed: Dec. 19, 2024

Related U.S. Application Data
(60) Provisional application No. 63/611,896, filed on Dec. 19, 2023.

(51) Int. Cl. G06F 16/34; G06F 16/35

(52) U.S. Cl. CPC G06F 16/345; G06F 16/35

(57) ABSTRACT

A method for mining conversation flows according to an embodiment includes receiving a plurality of transcripts of conversations between contact center agents and users, generating a summary of each transcript of the plurality of transcripts by extracting, for each transcript, one or more intents associated with the respective transcript and one or more slot entries associated with the respective transcript, clustering the plurality of transcripts into a plurality of intent categories based on the respective summary of each transcript, wherein each intent category includes intents that are similar to one another, and analyzing each transcript within a selected intent category of to generate a guided flow for the selected intent category, wherein the guided flow defines a set of actions to be taken by a human/virtual contact center agent to resolve an intent associated with the selected intent category.

### CROSS-REFERENCE TO RELATED APPLICATIONS

This application claims priority to and the benefit of U.S. Provisional Application No. 63/611,896, titled “Systems and Methods Relating to Mining Conversation Flows,” filed on Dec. 19, 2023, the contents of which are incorporated herein by reference in their entirety.

### BACKGROUND

Call centers and other contact centers are used by many organizations to provide technical and other support to their end users. The end user may interact with human and/or virtual agents of the contact center by establishing electronic communications via one or more communication technologies including, for example, telephone, email, web chat, Short Message Service (SMS), dedicated software application(s), and/or other technologies. Human and virtual agents alike leverage knowledge bases and follow various work flows when responding to end user inquiries.

### SUMMARY

One embodiment is directed to a unique system, components, and methods for mining conversation flows. Other embodiments are directed to apparatuses, systems, devices, hardware, methods, and combinations thereof for mining conversation flows.

According to an embodiment, a method for mining conversation flows may include receiving, by a computing system, a plurality of transcripts of conversations between contact center agents and users, generating, by the computing system, a summary of each transcript of the plurality of transcripts by extracting, for each transcript of the plurality of transcripts, one or more intents associated with the respective transcript and one or more slot entries associated with the respective transcript, clustering, by the computing system, the plurality of transcripts into a plurality of intent categories based on the respective summary of each transcript of the plurality of transcripts, wherein each intent category of the plurality of intent categories includes intents that are similar to one another, and analyzing, by the computing system, each transcript within a selected intent category of the plurality of intent categories to generate a guided flow for the selected intent category, wherein the guided flow defines a set of actions to be taken by a contact center agent to resolve an intent associated with the selected intent category.

In some embodiments, the method may further include configuring, by the computing system, a virtual agent based on the generated guided flow.

In some embodiments, the method may further include analyzing, by the computing system and for each intent category of the plurality of intent categories, each transcript within the respective intent category to generate a guided flow for the respective intent category, wherein the guided flow defines a set of actions to be taken by a contact center agent to resolve intents associated with the respective intent category.

In some embodiments, the method may further include configuring, by the computing system, a virtual agent based on guided flows generated for the respective intent categories.

In some embodiments, generating the summary of each transcript of the plurality of transcripts may include generating the summary of each transcript of the plurality of transcripts using a first large language model.

In some embodiments, clustering the plurality of transcripts into the plurality of intent categories may include consolidating similar intents using a second large language model.

In some embodiments, the first large language model may be different from the second large language model.

In some embodiments, clustering the plurality of transcripts into the plurality of intent categories may include generating a generalized intent description and slots for each intent category of the plurality of intent categories.

In some embodiments, clustering the plurality of transcripts into the plurality of intent categories may include modifying the consolidated intents based on user feedback.

In some embodiments, the method may further include clustering the plurality of intent categories into a plurality of domains, wherein each domain of the plurality of domains includes intent categories that are similar to one another.

According to another embodiment, a computing system for mining conversation flows may include at least one processor and at least one memory comprising a plurality of instructions stored therein that, in response to execution by the at least one processor, causes the computing system to receive a plurality of transcripts of conversations between contact center agents and users, generate a summary of each transcript of the plurality of transcripts by extracting, for each transcript of the plurality of transcripts, one or more intents associated with the respective transcript and one or more slot entries associated with the respective transcript, cluster the plurality of transcripts into a plurality of intent categories based on the respective summary of each transcript of the plurality of transcripts, wherein each intent category of the plurality of intent categories includes intents that are similar to one another, and analyze each transcript within a selected intent category of the plurality of intent categories to generate a guided flow for the selected intent category, wherein the guided flow defines a set of actions to be taken by a contact center agent to resolve an intent associated with the selected intent category.

In some embodiments, the plurality of instructions may further cause the computing system to configure a virtual agent based on the generated guided flow.

In some embodiments, the plurality of instructions may further cause the computing system to analyze, for each intent category of the plurality of intent categories, each transcript within the respective intent category to generate a guided flow for the respective intent category, wherein the guided flow defines a set of actions to be taken by a contact center agent to resolve intents associated with the respective intent category.

In some embodiments, the plurality of instructions may further cause the computing system to configure a virtual agent based on guided flows generated for the respective intent categories.

In some embodiments, to generate the summary of each transcript of the plurality of transcripts may include to generate the summary of each transcript of the plurality of transcripts using a first large language model.

In some embodiments, to cluster the plurality of transcripts into the plurality of intent categories may include to consolidate similar intents using a second large language model.

In some embodiments, the first large language model may be different from the second large language model.

In some embodiments, to cluster the plurality of transcripts into the plurality of intent categories may include to generate a generalized intent description and slots for each intent category of the plurality of intent categories.

In some embodiments, to cluster the plurality of transcripts into the plurality of intent categories may include to modify the consolidated intents based on user feedback.

In some embodiments, the plurality of instructions may further cause the computing system to cluster the plurality of intent categories into a plurality of domains, wherein each domain of the plurality of domains includes intent categories that are similar to one another.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a computing device;

FIG. 2 is a simplified block diagram of at least one embodiment of a contact center system and/or communications infrastructure;

FIG. 3 is a simplified block diagram of at least one embodiment of an architecture for leveraging conversation flow mining;

FIG. 4 is a simplified block diagram of at least one embodiment of an architecture for leveraging conversation flow mining;

FIG. 5 is a simplified block diagram of at least one embodiment of a chatbot architecture for leveraging conversation flow mining;

FIG. 6 is a simplified block diagram of at least one embodiment of an LLM-based chatbot architecture for leveraging conversation flow mining;

FIG. 7 is a simplified flow diagram of at least one embodiment of a method of conversation flow mining;

FIG. 8 is a simplified block diagram of at least one embodiment of an intent hierarchy;

FIGS. 9-11 illustrate slots expected by a model in an exemplary embodiment; and

FIG. 12 is a graphical representation of an output of a flow mining process.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

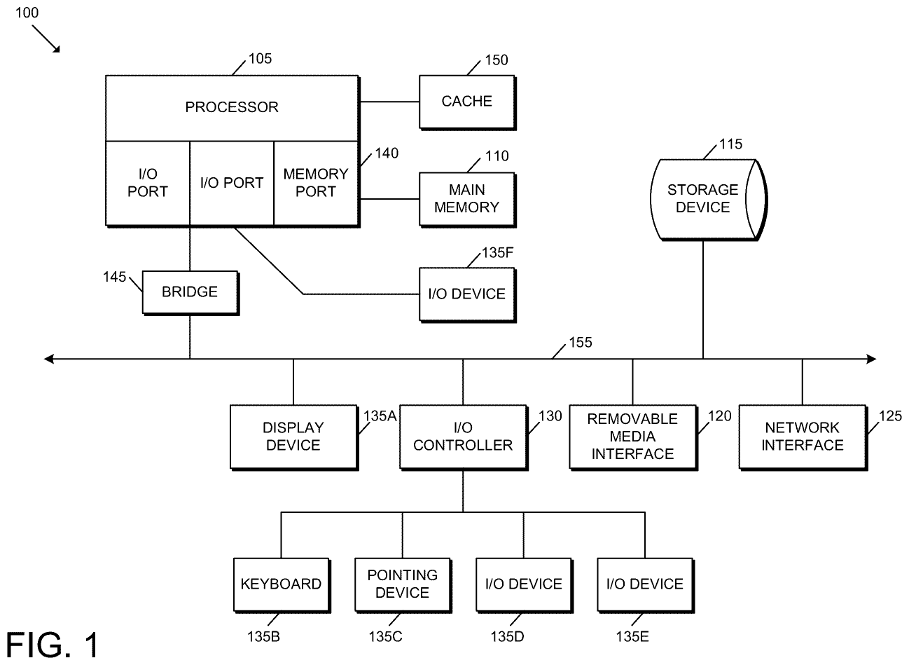

Referring now to FIG. 1, a simplified block diagram of at least one embodiment of a computing device 100 is shown. The illustrative computing device 100 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the servers may be a process or thread running on one or more processors of one or more computing devices 100, which may be executing computer program instructions and interacting with other system modules in order to perform the various functionalities described herein.

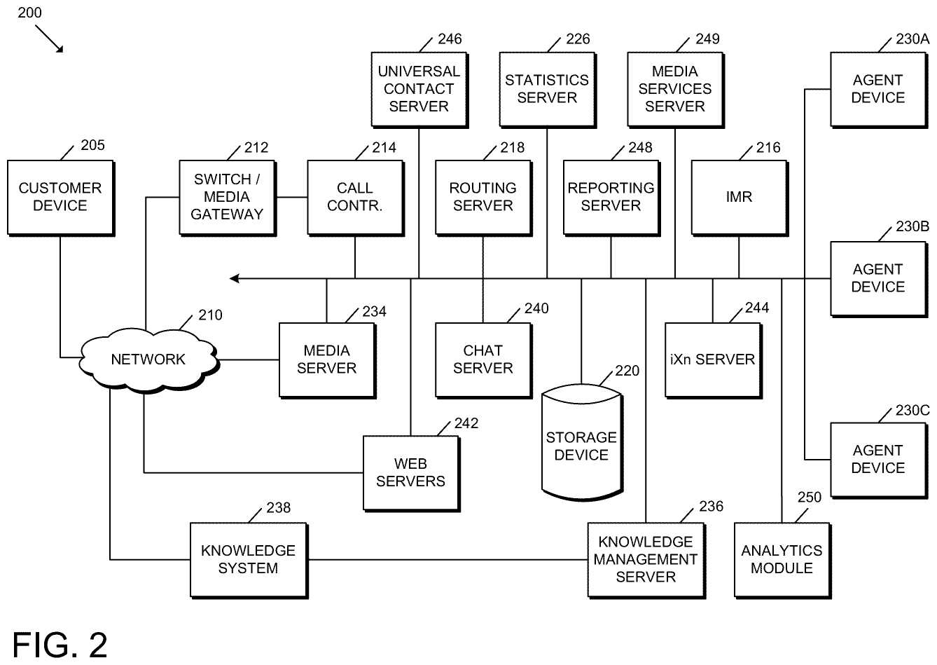

Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 200 of FIG. 2—the various servers and computing devices thereof may be located on local computing devices 100 (e.g., on-site at the same physical location as the agents of the contact center), remote computing devices 100 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

As shown in the illustrated example, the computing device 100 may include a central processing unit (CPU) or processor 105 and a main memory 110. The computing device 100 may also include a storage device 115, a removable media interface 120, a network interface 125, an input/output (I/O) controller 130, and one or more input/output (I/O) devices 135. For example, as depicted, the I/O devices 135 may include a display device 135A, a keyboard 135B, and/or a pointing device 135C. The computing device 100 may further include additional elements, such as a memory port 140, a bridge 145, one or more I/O ports, one or more additional input/output (I/O) devices 135D, 135E, 135F, and/or a cache memory 150 in communication with the processor 105.

The processor 105 may be any logic circuitry that responds to and processes instructions fetched from the main memory 110. For example, the processor 105 may be implemented by an integrated circuit (e.g., a microprocessor, microcontroller, or graphics processing unit), or in a field-programmable gate array (FPGA) or application-specific integrated circuit (ASIC). As depicted, the processor 105 may communicate directly with the cache memory 150 via a secondary bus or backside bus. It should be appreciated that the cache memory 150 typically has a faster response time than the main memory 110. The main memory 110 may be one or more memory chips capable of storing data and allowing stored data to be directly accessed by the processor 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices may include, for example, a keyboard 135B and a pointing device 135C (e.g., a mouse or optical pen). Output devices may include, for example, video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. Although described in the singular for clarity and brevity of the description, the computing device 100 may include a plurality of devices connected by a network or connected to other systems and resources via a network. As used herein, a network may be embodied as or include one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. For example, the network may be embodied as or include a private or public switched telephone network (PSTN), wireless carrier network, local area network (LAN), private wide area network (WAN), public WAN such as the Internet, etc., with connections being established using appropriate communication protocols. More generally, it should be understood that, unless otherwise limited, the computing device 100 may communicate with other computing devices 100 via any type of network using any suitable communication protocol. Further, the network may be a virtual network environment where various network components are virtualized. For example, the various machines may be virtual machines implemented as a software-based computer running on a physical machine, or a “hypervisor” type of virtualization may be used where multiple virtual machines run on the same host physical machine. Other types of virtualization may be employed in other embodiments.

Referring now to FIG. 2, a simplified block diagram of at least one embodiment of a communications infrastructure and/or content center system, which may be used in conjunction with one or more of the embodiments described herein, is shown. The contact center system 200 may be embodied as any system capable of providing contact center services (e.g., call center services, chat center services, SMS center services, etc.) to an end user and otherwise performing the functions described herein. The illustrative contact center system 200 includes a customer device 205, a network 210, a switch/media gateway 212, a call controller 214, an interactive media response (IMR) server 216, a routing server 218, a storage device 220, a statistics server 226, agent devices 230A, 230B, 230C, a media server 234, a knowledge management server 236, a knowledge system 238, chat server 240, web servers 242, an interaction (iXn) server 244, a universal contact server 246, a reporting server 248, a media services server 249, and an analytics module 250. Although only one customer device 205, one network 210, one switch/media gateway 212, one call controller 214, one IMR server 216, one routing server 218, one storage device 220, one statistics server 226, one media server 234, one knowledge management server 236, one knowledge system 238, one chat server 240, one iXn server 244, one universal contact server 246, one reporting server 248, one media services server 249, and one analytics module 250 are shown in the illustrative embodiment of FIG. 2, the contact center system 200 may include multiple customer devices 205, networks 210, switch/media gateways 212, call controllers 214, IMR servers 216, routing servers 218, storage devices 220, statistics servers 226, media servers 234, knowledge management servers 236, knowledge systems 238, chat servers 240, iXn servers 244, universal contact servers 246, reporting servers 248, media services servers 249, and/or analytics modules 250 in other embodiments. Further, in some embodiments, one or more of the components described herein may be excluded from the system 200, one or more of the components described as being independent may form a portion of another component, and/or one or more of the components described as forming a portion of another component may be independent.

It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another embodiment, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the technologies described herein may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

It should be understood that any of the computer-implemented components, modules, or servers described in relation to FIG. 2 may be implemented via one or more types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 200 may initiate inbound communications (e.g., telephone calls, emails, chats, etc.) to the contact center system 200 via a customer device 205. While FIG. 2 shows one such customer device—i.e., customer device 205—it should be understood that any number of customer devices 205 may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of the network typically depending on the type of customer device being used and the form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 212 may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 212 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VOIP calls, and/or other types of calls. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

The interactive media response (IMR) server 216 may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may instruct customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment (e.g. Genesys® Designer).

The routing server 218 may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described herein, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

It should be appreciated that the contact center system 200 may include one or more mass storage devices—represented generally by the storage device 220—for storing data in one or more databases relevant to the functioning of the contact center. For example, the storage device 220 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database. Agent data maintained by the contact center system 200 may include, for example, agent availability and agent profiles, schedules, skills, handle time, and/or other relevant data. As another example, the storage device 220 may store interaction data in an interaction database. Interaction data may include, for example, data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therein or transmit data thereto for storage. The storage device 220, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 226 may be configured to record and aggregate data relating to the performance and operational aspects of the contact center system 200. Such information may be compiled by the statistics server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center system 200 may be communication devices configured to interact with the various components and modules of the contact center system 200 in ways that facilitate functionality described herein. An agent device 230, for example, may include a telephone adapted for regular telephone calls or VoIP calls. An agent device 230 may further include a computing device configured to communicate with the servers of the contact center system 200, perform data processing associated with operations, and interface with customers via voice, chat, email, and other multimedia communication mechanisms according to functionality described herein. Although FIG. 2 shows three such agent devices 230—i.e., agent devices 230A, 230B and 230C—it should be understood that any number of agent devices 230 may be present in a particular embodiment.

The multimedia/social media server 234 may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 236 may be configured to facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials. As an example, the knowledge system 238 may be embodied as IBM Watson or a similar system.

The chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage, and facilitate user interfaces (UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 236 and the knowledge systems 238 for receiving suggestions and answers to queries posed by customers during a chat so that, for example, links to relevant articles can be provided.

The web servers 242 may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 244 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferrable activities. Once assigned to a particular agent, the deferrable activity is pushed to that agent so that it appears on the agent device 230 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 230 may include a workbin. As an example, a workbin may be maintained in the buffer memory of the corresponding agent device 230.

The universal contact server (UCS) 246 may be configured to retrieve information stored in the customer database and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 249 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 250 may be configured to provide systems and methods for performing analytics on data received from a plurality of different data sources as functionality described herein may require. In accordance with example embodiments, the analytics module 250 also may generate, update, train, and modify predictors or models (e.g., machine learning models) based on collected data, such as, for example, customer data, agent data, and interaction data. The models may include behavior models of customers or agents. The behavior models may be used to predict behaviors of, for example, customers or agents, in a variety of situations, thereby allowing embodiments of the technologies described herein to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database and agent database. The analytics module 250 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 250 may be configured to retrieve data stored within the storage device 220 for use in developing and training algorithms and models, for example, by applying machine learning techniques.

One or more of the included models (e.g., artificial intelligence-based models, including machine learning models, such as neural networks, deep learning models, and/or other types of models) may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 250 may further include an optimizer. The optimizer may include and/or leverage one or more models, which may include machine learning models. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 250 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers in various embodiments. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment. It should be appreciated that each of the devices of the call center system 200 may be embodied as, include, or form a portion of one or more computing devices similar to the computing device 100 described below in reference to FIG. 1.

It should be appreciated that the natural language conversations between contact center agents and users may be transcribed into text and stored for analysis. However, analyzing such textual data can be challenging due to the substantial volume of data available for analysis. Accordingly, the technologies described herein allow for the processing of raw conversations between contact center agents and users to extract both intents and the steps taken therein (e.g., the conversation flow) into guided flows. It should be appreciated that a guided flow may be generated from a set of conversations having the same (or similar) intents as a generalized set of steps to be taken (e.g., by the contact center agent and/or user) to address the relevant intent. It should be further appreciated that the generated guided flows may include a data structure that can be readily employed as agent guides (e.g., for an agent co-pilot) that assist contact center agents during live interactions with the users, and/or used to configured agent bots or virtual agents (e.g., chatbots).

Flow mining refers to the process of analyzing conversation transcripts and extracting patterns (or other data from which patterns can be ascertained) that represent the likely flow(s) of the conversation. It should be appreciated that a particular mined flow can be visually represented as a state machine, where the state machine includes a set of states at which a conversation could be in and its context within the respective states. A mined flow may provide an aggregated view of the most common pattern of states present in a set of conversations and their most common sequence of events. For example, for conversations containing a booking_flight intent, the most likely first slot may be the destination/arrival city, which may then become the first state in the booking_flight flow. In some embodiments, the flows are mined using a multi-step approach and leveraging one or more large language models (LLMs) as described herein.

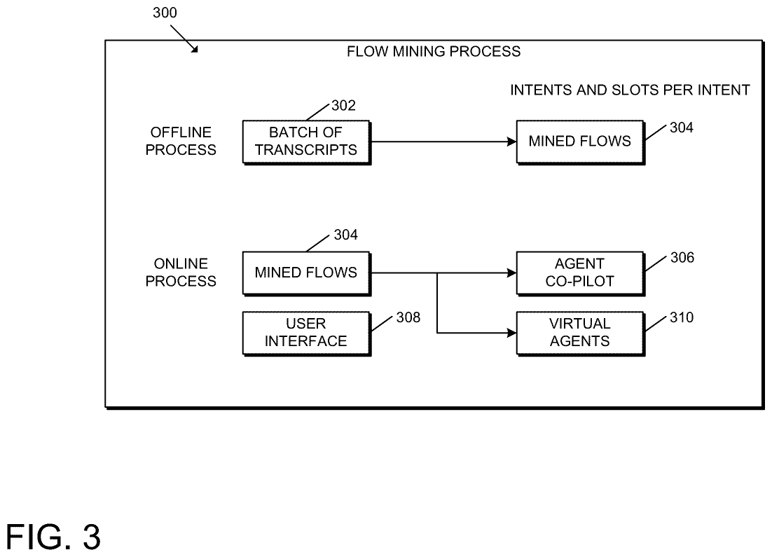

Referring now to FIG. 3, an architecture 300 for leveraging conversation flow mining may divide the flow mining process into an offline process and an online process. During the offline process, a computing system (e.g., the computing device 100, the contact center system 200, and/or other computing devices described herein) processes a batch/set of transcripts 302 to generate mined flows 304 (e.g., static flows). In doing so, as described herein, the computing system may determine a set of intents and slots for each of the intents. It should be appreciated that the particular conversations/transcripts selected for processing may vary depending on the particular embodiment. For example, in some embodiments, the flows may be mined from conversations manually selected by a supervisor or administrator to generate high-quality flows that could serve to guide future interactions of the same type. Further, in some embodiments, the computing system may also determine a sequence of events to take place to resolve the intents.

During the online process, the computing system may use the mined flows 304 to support various applications within the contact center system. For example, the mined flows 304 may be used to guide both virtual and human agents during their interactions with contact center users. In particular, in some embodiments, the mined flows 304 may support and guide human agents in their interactions with users via an agent co-pilot 306, for example, by showing the identified intents and corresponding required slots that the contact center agent should collect from users during the interaction. Suggested slots may be shown as tasks that the contact center agent needs to complete to address a particular intent. Further, using large language models, the agent co-pilot 306 may also suggest agent responses that can be sent to the user, for example, in only a few clicks on a user interface 308. In other embodiments, the mined flows 304 may be used to provide clear instructions to virtual agents 310 and control their behavior (e.g., which may help reduce or eliminate hallucinations from a generative artificial intelligence system), helping the virtual agents 310 to leverage scripts to achieve their defined goals.

In some embodiments, the flow mining process may involve intents extraction, slots extraction, intents reduction, slots reduction, and conversation analysis, each of which may include input, prompt, and output components. For example, in some embodiments, during the intents extraction phase of the flow mining process, the computing system may take raw conversation data (e.g., transcript data) of conversations between contact center agents and users, and extract the intent name, sub-intent name, detailed summary, short description, and user inputs for each conversation/transcript. The intents and sub-intents extracted from processing the previous conversation may be passed on to prompts to use existing intents and sub-intents (e.g., when a consistent set of intents is desired). This extraction process may be run for each conversation/transcript in the dataset. During the slot extraction phase of the flow mining process, the computing system extracts a list of slots (e.g., entity names/types) based on the detailed description from the intent extraction phase for each intent and/or sub-intent. During the intents reduction phase of the flow mining process, the computing system may reduce the number of sub-intents based on the detailed description of the sub-intents. It should be appreciated that there intent reduction phase may be a multi-stage process in some embodiments. During the slots reduction phase of the flow mining process, the computing system may reduce or remove duplicate slows for each intent. During the conversation analysis phase of the flow mining process, the computing system may use the intents and slots extracted from the previous stages (e.g., as reduced) and the conversation transcripts to generate utterance-level conversation analysis of the transcripts.

Exemplary input, prompt, and output data for each of the intents extraction, slots extraction, intents reduction, slots reduction, and conversation analysis phases of the flow mining process are provided below for illustrative purposes.

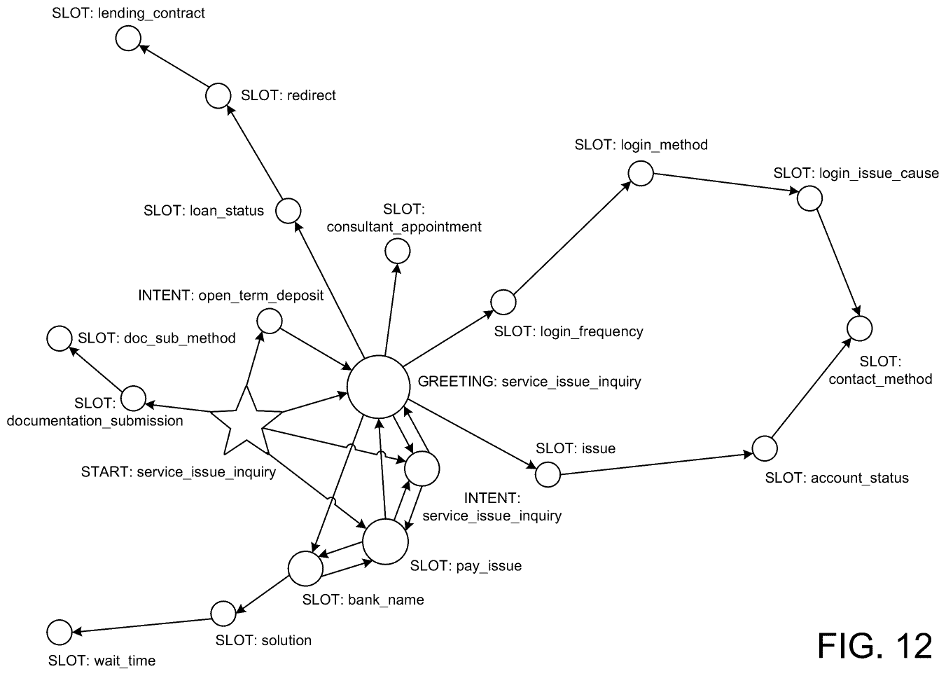

It should be appreciated that the mined flows may be graphically represented as a state diagram, mapped flow, or flow graph on a graphical user interface 308 to allow a contact center agent, administrator, or other user to visualize the conversation flow. For example, in an embodiment, a mined flow such as that represented in FIG. 12 may be generated from the following analyzed conversations:
Conversation 1:
   agent: Hi, how can I help you today?
   user: I'm trying to set up internet banking but as I'm entering member number it say invalid.
   agent: Has it been a long time since you logged into Internet Banking through the web browser?
   agent: It sounds like your Internet Banking may be locked or inactive.
   agent: So we can look further into this, can you please call us on 986543367.
   agent: Or visit a branch?
   agent: Or send a secure message by Internet Banking/Mobile App?
   agent: Unfortunately I cannot access your account via live chat as this is an unsecured source.
   agent: Can I assist you with anything else today?
   agent: If you need further assistance please resume chatting, have a great day!
Conversation 2:
   user: good afternoon. We are a not for profit club who would like to have the ability for members to pay us using a card. Do you have mobile terminals.
   agent: Hi, Thanks for getting in touch.
   agent: We do have a service we recommend called Tyro.
   agent: You can find all the information and enquiry form in the link aboce.
   agent: above*
   user: Hi Paul can you tell me if it works similar to a square reader or terminal, is it portable and what would be the costs.
   agent: They are eftpos machines, one of the options is portible with Wifi and a long life rechargeable battery.
   agent: I am not a member of the business banking team and not sure of all the ins and outs. I do know there are no set up costs. In the link provided there is an enquiry form which would prompt a business banker to contact you and discuss if the service is a good fit for you.
   agent: Are you able to complete the enquiry form?
   agent: Is there anything else I could help with today?
   agent: If you still need assistance please resume chatting, have a great day!
Conversation 3
   user: just checking if there is an issue with the bank today.
   user: as my pay has not come through as yet.
   user: don't worry, can now see the general warning on the website—that there are card and payment issues.
   agent: customer: don't worry, can now see the general warning on the website—that there are card and payment issues.
Conversation 4
   agent: Hi and thank you for contacting us.
   agent: How can I help you today?
   user: I need assistance with my mortgage repayments.
   user: mortgage.
   agent: Unfortunately, I am unable to access your accounts/services via Live Chat as it is considered an unsecure channel.
   agent: Please call us on 41352462 (option 3 and one of our Lending Specialists can assist you further.
   user: thank you.
   agent: You're welcome. Is there anything else I can help with?
   agent: Thank you for your time and have a great day.
Conversation 5
   user: Hi I need a postal address for a deceased estate matter.
   agent: Hi there.
   agent: Unfortunately I cannot provide any personal details of any member over this chat service as it isn't secure.
   agent: Can you please contact us on 245467485 or visit your nearest branch for assistance.
   agent: Are you there? Are you still requiring further assistance? agent: I will end the chat now, if you still require assistance please contact us.
Conversation 6
   agent: Hi and thank you for contacting us.
   agent: How can I help?
   user: Hi, I have a homeloan with BB, how do I find out how long I have left on the loan?
   agent: We can certainly look at that for you, however, I can't access your account over Live Chat as it's considered to be unsecure. To look further into this, we will need for you to contact us directly.
   agent: You can contact us by one of the below secure methods.
   agent: Is there anything else I can help with today?
   user: I can access online, and view my statements-why is that information not available to me?
   agent: Unfortunately, I'm not a Lending Consultant so I'm unsure. Our Lending Team will certainly be able to help you if you contact us via the above secure methods. I apologise for the inconvenience.
Conversation 7
   user: Hi There.
   user: Trying to reset my password online, I get the link for a temp passwords but when I enter always says its wrong.
   agent: Hi and thank you for contacting us.
   agent: It sounds like your Internet Banking may have gone Inactive.
   agent: This can occur if you have not logged into your Internet Banking via the web browser for 2 months or more, even if you use the App.
   user: yep i do use the app.
   agent: This would prevent you from logging into the App on a new device or successfully resetting your password.
   user: how do i fix this.
   agent: Unfortunately, I am unable to access your accounts/services via Live Chat as it is considered an unsecure channel.
   agent: Please call us on 15954357 (option 2 and one of our consultants can assist you with activating your Internet Banking and getting you logged in.
   agent: They will be able to help quite quickly.
   user: ok.
   user: Will do thank you.
   agent: There is a bit of a wait on the phones right now. About 15 mins. user: it is what it is.
   agent: when you have gone through the initial part, you can select option 3 to request a call back and keep your place in the queue.
   agent: Is there anything else I can help with today?
   agent: Thank you for your time and have a great day.
Conversation 8
   user: Hello, I have got a new phone and trying to login to my banking app and it is telling me my member number and password is wrong but it's an automated password sent by you guyd.
   agent: Hi, Thanks for getting in touch.
   agent: Has it been a long time since you logged into Internet Banking through the web browser?
   user: I'm not sure I had my last phone 3 years.
   agent: Were you using the Mobile App or accessing Internet Banking through the web browser?
   user: Mobile app.
   agent: It sounds like your Internet Banking may be locked or inactive. This happens when you do not log into the web browser version for 10 months.
   agent: So we can look further into this, can you please call us on 3341356.
   agent: Or visit a branch?
   agent: Or send a secure message by Internet Banking/Mobile App?
   agent: Unfortunately I cannot access your account via live chat as this is an unsecured source.
   agent: Are you still there?
   agent: If you need further assistance please resume chatting, have a great day!

Another example embodiment of the flow mining process is described below. For example, in an illustrative embodiment, the computing system summarizes each conversation/transcript using a large language model (e.g., the Claude instant generative artificial intelligence model). It should be appreciated that each conversation may be analyzed in parallel and may take approximately 2.5 seconds for execution for each conversation. The resulting summary may be in a format that includes intent name, summary, sub-intent name, and user input. The user input may include details of the type(s) of slot values that the user has provided. For example, the conversation summary may be generated as:

```
  “summary”: {
    “intent_name”: “Find_flight”,
    “detailed_summary”: “The user wanted to find a round trip commercial airline
      flight from Seattle to Chicago with the earliest departure today in economy
      class and returning 3 days later in the morning. The agent found a nonstop
      flight leaving at 6:03 pm for $334 and the user booked a return flight at 3:17
      pm for the same price making the total $334.”,
    “short_description”: “Find cheapest nonstop economy flights from Seattle to
      Chicago today and returning in 3 days.”,
    “sub_intent_name”: “Book_flight”,
    “user_input”: “Find cheapest nonstop economy flights from Seattle to Chicago
      today departing as early as possible and returning in 3 days in the morning.”
}
```

In the exemplary embodiment, the computing system may consolidate intents using a large language model (e.g., the Claude v2 generative artificial intelligence model). In some embodiments, it should be appreciated that the large language model used for summarization may be different form the large language model used for consolidating the intents. For example, the large language model for summarization may be a lighter weight model than the model used for consolidation. In the exemplary embodiment, the number of sub-intents generated from the conversation in the previous step (300 intents) is reduced/consolidated to 48 intents, as the previous data could be improved to reduce the number of sub-intents. In the exemplary embodiment, the computing system processes the user inputs from all of the conversations in a sub-intent to generate a generalized intent, description, and slots. An example output of this consolidation step may be generated as:

```
{
    “description”: “This intent is for booking a flight ticket. It captures details like
  departure city, arrival city, departure date, return date, number of passengers,
  class of ticket (economy, business etc), budget, meal preference, seating
  preference, flight time preference (morning, evening etc), number of layovers,
  airline preference. \n\nPossible slots are:\n- departure_city: city from where
  user wants to depart e.g. New York, San Francisco\n- arrival_city: city where
  user wants to arrive e.g. London, Paris\n- departure_date: date on which user
  wants to depart\n- return_date: return date for round trip\n- num_passengers:
  number of passengers traveling\n- class: class of ticket - economy, business\n-
  budget: maximum budget for ticket\n- meal: meal preference - vegetarian, non-
  vegetarian\n- seating: seating preference - window, aisle\n- departure_time:
  preferred departure time - morning, evening\n- num_layovers: maximum
  number of layovers acceptable\n- airline: preferred airline if any\n”,
    “slots”: [
      {
        “name”: “departure_city”,
        “description”: “city from where the user wants to depart”,
        “example”: [
          “New York”,
          “San Francisco”,
          “Houston”
        ]
      },
      {
        “name”: “arrival_city”,
        “description”: “city where the user wants to arrive”,
        “example”: [
          “London”,
          “Paris”,
          “Berlin”
        ]
      },
      {
        “name”: “departure_date”,
        “description”: “date on which the user wants to depart”,
        “example”: [
          “March 10”,
          “August 10”
        ]
      },
      {
        “name”: “return_date”,
        “description”: “return date for a round trip booking”,
        “example”: [
          “March 20”,
          “August 20”
        ]
      },
      {
        “name”: “num_passengers”,
        “description”: “number of passengers traveling”,
        “example”: [
          “1”,
          “2”
        ]
      },
      {
        “name”: “class”,
        “description”: “class of ticket - economy, business, first class”,
        “example”: [
          “economy”,
          “business”
        ]
      },
      {
        “name”: “budget”,
        “description”: “maximum budget for the ticket”,
        “example”: [
          “$1000”,
          “$600”
        ]
      },
      {
        “name”: “meal”,
        “description”: “meal preference - vegetarian, non-vegetarian”,
        “example”: [
          “vegetarian”,
          “non-vegetarian”
        ]
      },
      {
        “name”: “seating”,
        “description”: “seating preference - window, aisle”,
        “example”: [
          “window”,
          “aisle”
        ]
      },
      {
        “name”: “departure_time”,
        “description”: “preferred departure time - morning, evening, night”,
        “example”: [
          “morning”,
          “evening”
        ]
      },
      {
        “name”: “num_layovers”,
        “description”: “maximum number of layovers acceptable”,
        “example”: [
          “1”,
          “2”
        ]
      },
      {
        “name”: “airline”,
        “description”: “preferred airline if any”,
        “example”: [
          “United”,
          “Lufthansa”
        ]
      }
    ]
}
```

It should be appreciated that, in some embodiments, the intents and/or sub-intents generated in the previous step(s) may be overlapping and/or closely related to one another. Accordingly, in the exemplary embodiment, the computing system may generate a simplified set of intents using a large language model (e.g., the Claude v2 generative artificial intelligence model), by reducing the number of sub-intents. In the exemplary embodiment, the number of sub-intents previously generated (48 intents) is reduced/simplified to 8 intents, which are clearly separated (partitioned) from one another in terms of scope. An example of the simplification may be generated as:

```
[
  {
      “simplified_sub_intent_name”: “book_flight”,
      “description”: “Book a flight given origin, destination, travel dates,
    passengers, preferences.”,
      “original_reduced_map”: [
        “flight_booking@flight_booking_details”,
        “flight_booking@flight_details”,
        “flight_booking@one_way_flight_booking”
      ]
  },
  {
      “simplified_sub_intent_name”: “book_multi_city_flight”,
      “description”: “Book a multi-city flight given origin, multiple destinations,
    dates, passengers, preferences.”,
      “original_reduced_map”: [
        “flight_booking@multi_city_flight_booking”,
        “flight_booking@flight_booking_multi_city”,
        “find_flight@book_multi_city_flight”,
        “find_flight@book_cheapest_multi_city_flight”,
        “book_flight@book_multi_city_flight”,
        “book_multi_city_flight@book_first_class_multi_city_flight”,
        “book_multi_city_flight@book_multi_city_flight”
      ]
  },
  {
      “simplified_sub_intent_name”: “book_round_trip_flight”,
      “description”: “Book a round trip flight given details like departure city,
    destination city, departure and return dates, number of travelers, flight
    preferences like nonstop, amenities, time of day, and budget.”,
      “original_reduced_map”: [
        “flight_booking@flight_booking”,
        “flight_booking@round_trip_flight_booking”,
        “find_flight@cheap_flight”,
        “find_flight@book_flight”,
        “find_flight@book_cheapest_flight”,
        “find_flight@book_cheapest_round_trip_flight”,
        “book_flight@book_cheapest_round_trip_flight”,
        “book_flight@book_flight”,
        “book_flight@book_business_class_round_trip_flight”,
        “book_flight@book_first_class_round_trip_flight”,
        “book_flight@book_round_trip_flight”,
        “book_flight@book_cheapest_round_trip_economy_flight”,
        “book_round_trip_flight@book_round_trip_flight”,
        “book_round_trip_flight@book_cheapest_round_trip_flight”,
        “book_round_trip_flight@book_first_class_round_trip_flight”,
        “book_round_trip_flight@book_round_trip_economy_flight”,
        “book_round_trip_flight@book_cheapest_round_trip_economy_flight”,
        “book_round_trip_flight@book_round_trip_flight_with_stops”,
        “book_first_class_flight@book_first_class_round_trip_flight”
      ]
  },
  {
      “simplified_sub_intent_name”: “book_flight_with_class”,
      “description”: “Book a flight with specific class given details like departure
    city, destination city, travel dates, flight class, nonstop preference, and number
    of travelers.”,
      “original_reduced_map”: [
        “book_flight@book_one_way_business_class_flight”,
        “book_flight@book_cheapest_business_class_flight”,
        “book_flight@book_first_class_flight”,
        “book_flight@book_economy_premium_flight”,
        “book_flight@book_first_class_morning_flight”,
    “book_round_trip_flight@book_cheapest_business_class_round_trip_flight”
      ]
  },
  {
      “simplified_sub_intent_name”: “book_nonstop_flight”,
      “description”: “Book a nonstop flight with slots for departure airport, arrival
    airport, departure date, return date, airline, departure time preference”,
      “original_reduced_map”: [
        “book_flight@book_cheapest_flight”,
        “book_flight@book_nonstop_flight”,
        “book_flight@book_one_way_nonstop_flight”,
        “book_flight@book_business_class_nonstop_flight”,
        “book_flight@book_first_class_nonstop_flight”,
        “book_flight@book_nonstop_economy_flight”,
        “book_flight@book_economy_flight”,
        “book_flight@book_cheapest_one_way_economy_flight”,
        “book_flight@book_cheapest_economy_flight”,
        “book_flight@book_business_class_nonstop_round_trip_flight”,
        “book_flight@book_cheapest_round_trip_nonstop_flight”,
        “book_round_trip_flight@book_nonstop_round_trip_economy_flight”,
        “book_round_trip_flight@book_first_class_nonstop_round_trip_flight”,
        “book_round_trip_flight@book_nonstop_round_trip_flight”,
        “book_round_trip_flight@book_cheapest_round_trip_nonstop_flight”,
        “book_round_trip_flight@book_nonstop_round_trip_afternoon_flight”,
    “book_round_trip_flight@book_business_class_nonstop_round_trip_flight”,
        “book_round_trip_flight@book_nonstop_round_trip_morning_flight”,
        “book_first_class_flight@book_first_class_nonstop_flight”,
        “book_one_way_flight@book_one_way_flight”
      ]
  }
]
```

In some embodiments, the computing system may solicit user feedback regarding the definitions of and/or number of the intents, sub-intents, and/or slots as simplified/reduced. For example, in the exemplary embodiment, the computing system selects a sub-intent, generates slots, and further refines those slots based on user feedback (e.g., provided by a user interface). An example of how this may be performed is provided:

```
{
  “required_slots”: [
    {
      “name”: “departure_city”,
      “description”: “city from where the user wants to depart”,
      “example”: [
        “New York”,
        “San Francisco”,
        “Houston”
      ]
    },
    {
      “name”: “arrival_city”,
      “description”: “city where the user wants to arrive”,
      “example”: [
        “London”,
        “Paris”,
        “Berlin”
      ]
    },
    {
      “name”: “depart_date”,
      “description”: “departure date for flight booking”,
      “example”: [
        “Saturday May 13th”,
        “Tuesday June 20th”
      ]
    },
    {
      “name”: “return_date”,
      “description”: “return date for the inbound flight”,
      “example”: [
        “May 20”,
        “June 25”,
        “July 15”
      ]
    },
    {
      “name”: “num_passengers”,
      “description”: “number of passengers traveling”,
      “example”: [
        “1”,
        “2”
      ]
    }
  ],
  “optional_slots”: [
    {
      “name”: “airline”,
      “description”: “airline of the flight”,
      “example”: [
        “United”,
        “Lufthansha”
      ]
    },
    {
      “name”: “flight_class”,
      “description”: “flight class for flight booking”,
      “example”: [
        “first class”,
        “business class”,
        “economy class”
      ]
    },
    {
      “name”: “meal”,
      “description”: “meal preference - vegetarian, non-vegetarian”,
      “example”: [
        “vegetarian”,
        “non-vegetarian”
      ]
    },
    {
      “name”: “seat”,
      “description”: “preferred seat specified by the user e.g. aisle, window”,
      “example”: [
        “aisle”
      ]
    }
  ]
}
```

In the exemplary embodiment, the computing system generates a guided flow for each conversation/transcript with a selected sub-intent and for the slots considered. An example mined flow is provided related to the “book round trip flight” sub-intent:

```
{
  “conversation_id”: “dlg-720a2958-8406-4a18-af5c-ba3d22827dd6”,
  “conversation_analysis”: [
    {
      “AGENT”: “How can I help you?”,
      “acts”: [
        {
          “act”: “REQUEST”,
          “slot”: “intent”,
          “value”: “”
        }
      ]
    },
    {
      “USER”: “I would like help in finding a flight to London.”,
      “acts”: [
        {
          “act”: “INFORM_INTENT”,
          “slot”: “intent”,
          “value”: “book_flight”
        },
        {
          “act”: “INFORM”,
          “slot”: “arrival_city”,
          “value”: “London”
        }
      ]
    },
    {
      “AGENT”: “May I please have the details?”,
      “acts”: [
        {
          “act”: “REQUEST”,
          “slot”: “”,
          “value”: “”
        }
      ]
    },
    {
      “USER”: “Leaving tomorrow for 1 week.”,
      “acts”: [
        {
          “act”: “INFORM”,
          “slot”: “depart_date”,
          “value”: “tomorrow”
        },
        {
          “act”: “INFORM”,
          “slot”: “return_date”,
          “value”: “1 week”
        }
      ]
    },
    {
      “AGENT”: “Okay. Is that all?”,
      “acts”: [
        {
          “act”: “REQ_MORE”,
          “slot”: “”,
          “value”: “”
        }
      ]
    },
    {
      “USER”: “I'd like a flight in the morning.”,
      “acts”: [
        {
          “act”: “INFORM”,
          “slot”: “depart_time”,
          “value”: “morning”
        }
      ]
    },
    {
      “AGENT”: “Is that all?”,
      “acts”: [
        {
          “act”: “REQ_MORE”,
          “slot”: “”,
          “value”; “”
        }
      ]
    },
    {
      “USER”: “I'd like first class seating.”,
      “acts”: [
        {
          “act”: “INFORM”,
          “slot”: “flight_class”,
          “value”: “first class”
        }
      ]
    },
    {
      “AGENT”: “Okay sure. Is that all?”,
      “acts”: [
        {
          “act”: “REQ_MORE”,
          “slot”: “”,
          “value”: “”
        }
      ]
    },
    {
      “USER”: “I'd like the flight to be Non-stop.”,
      “acts”: [
        {
          “act”: “INFORM”,
          “slot”: “stops”,
          “value”: “non-stop”
        }
      ]
    },
    {
      “AGENT”: “I found a flight departing at 4:35 P.M, non-stop with British
      Airways.”,
      “acts”: [
        {
          “act”: “OFFER”,
          “slot”: “flight”,
          “value”: “4:35pm non-stop British Airways”
        }
      ]
    },
    {
      “USER”: “Yes.”,
      “acts”: [
        {
          “act”: “AFFIRM”,
          “slot”: “”,
          “value”: “”
        }
      ]
    },
    {
      “AGENT”: “Okay great. Is that all?”,
      “acts”: [
        {
          “act”: “REQ_MORE”,
          “slot”: “”,
          “value”: “”
        }
      ]
    },
    {
      “USER”: “Yes, That is all.”,
      “acts”: [
        {
          “act”: “AFFIRM”,
          “slot”: “”,
          “value”: “”
        }
      ]
    },
    {
      “AGENT”: “Goodbye.”,
      “acts”: [
        {
          “act”: “GOODBYE”,
          “slot”: “”,
          “value”: “”
        }
      ]
    }
  ]
}
```

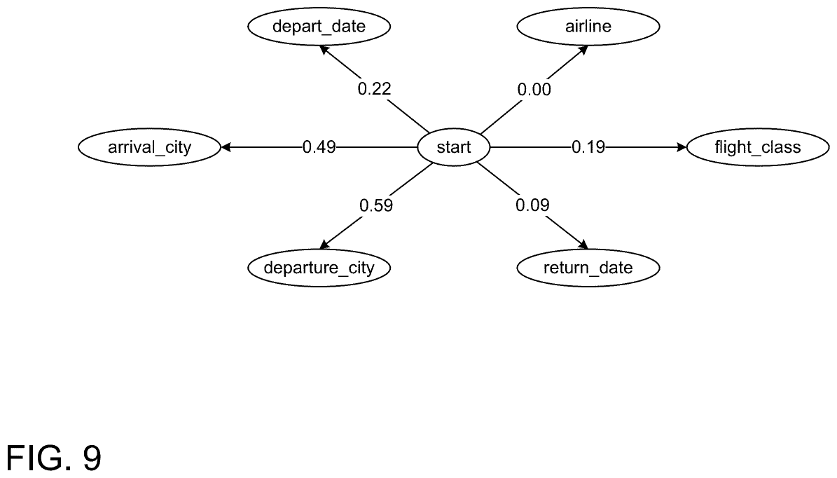

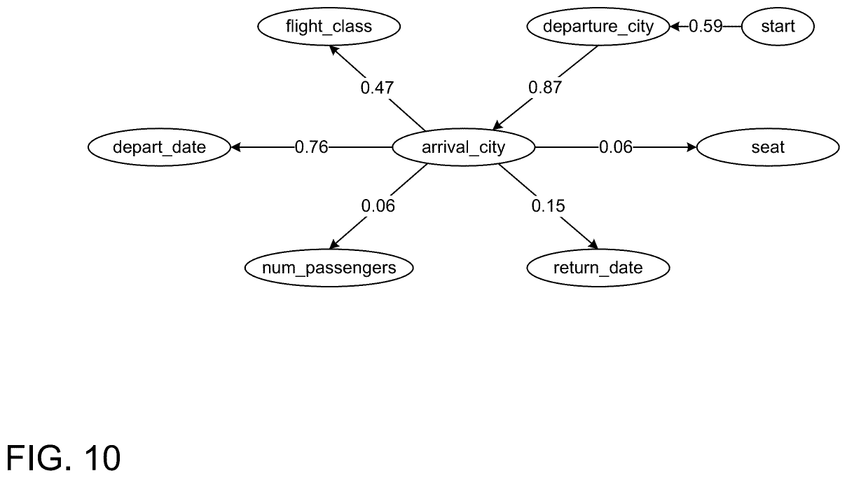

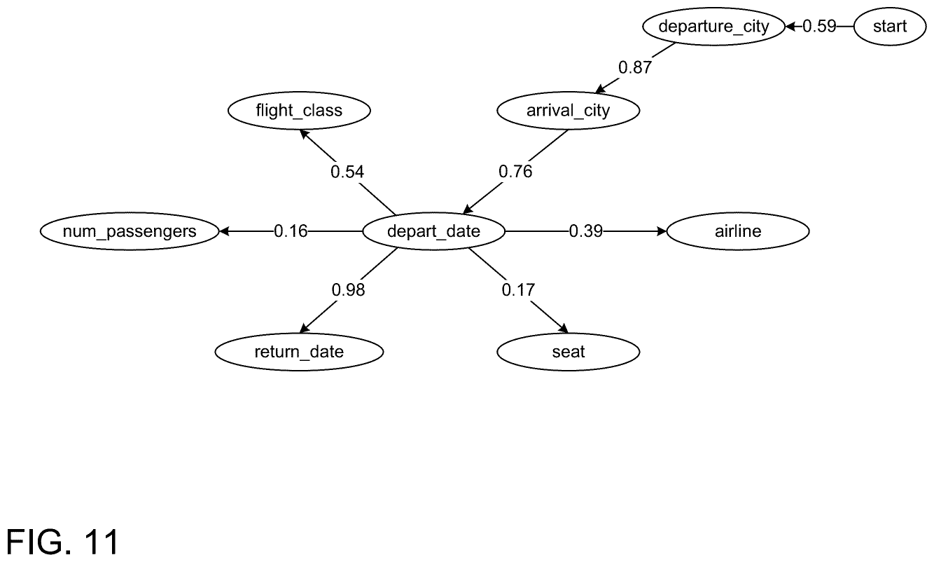

According to a particular implementation, a set of 300 conversations were analyzed in a manner consistent with the technologies described herein for mining conversation flows. In the exemplary embodiment, the selected sub-intent “book round trip flight” had the following slots: airline, arrival city, depart date, departure city, flight class, meal, number of passengers, return date, and seat. FIGS. 9-11 illustrate the slots expected by a model in the illustrative embodiment and the respective weights for transitioning between various slots (e.g., states of a state machine). As depicted in FIGS. 9-11, the most likely transition is from start to departure city to arrival city to departure date and then to return date.

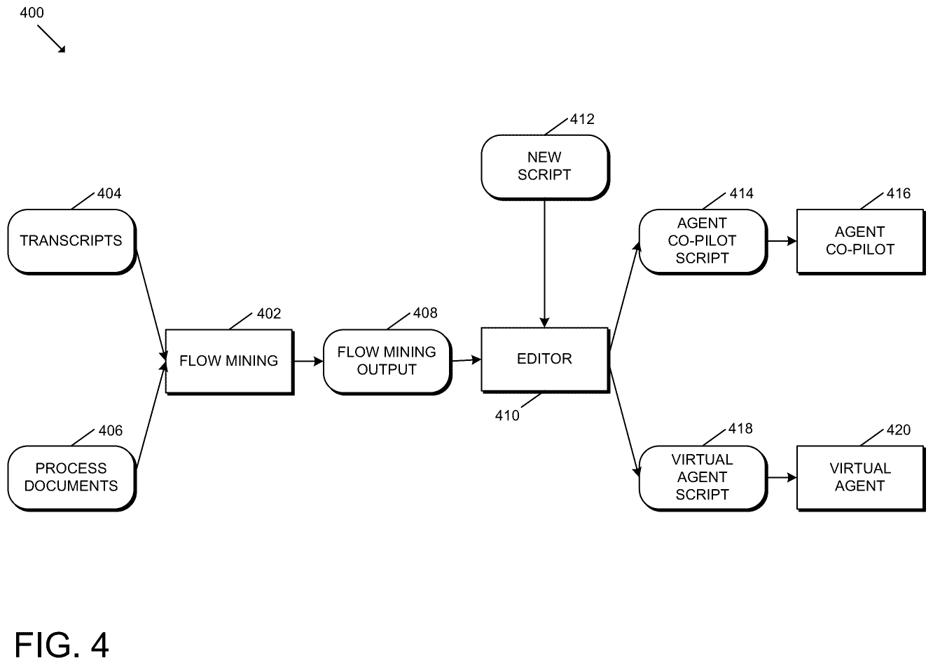

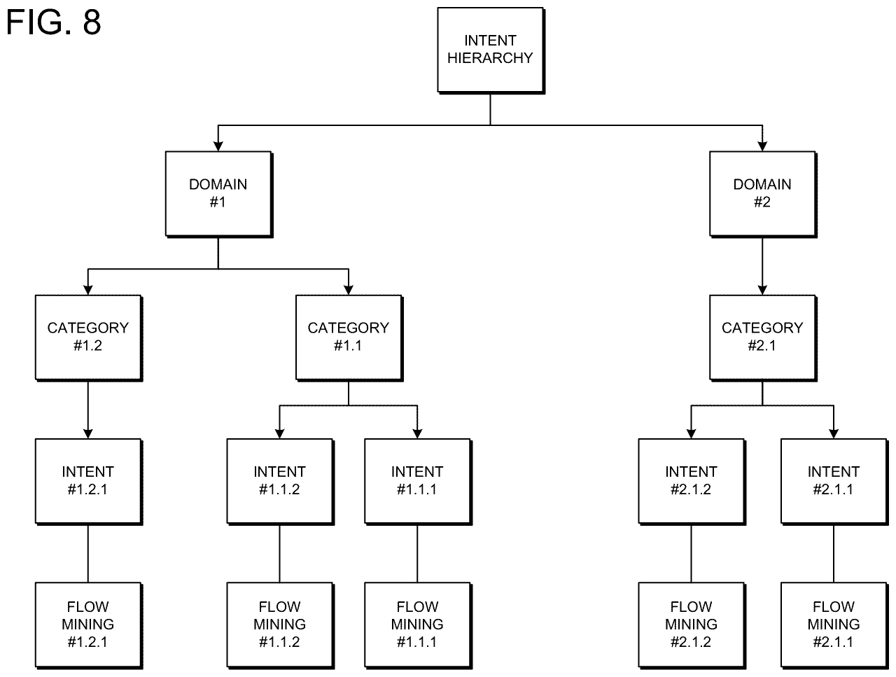

Referring now to FIG. 4, an architecture 400 for leveraging conversation flow mining is shown. As shown, a computing system (e.g., the computing device 100, the contact center system 200, and/or other computing devices described herein) performs flow mining 402 on a set of transcripts 404 of conversations between contact center agents and users as described herein. Further, in some embodiments, the computing system may also mine process documents 406 during the flow mining process. It should be appreciated that the process documents may be any set of documents consistent with the other features described herein (e.g., knowledge base documents, workforce management documents, etc.). As described herein, the flow mining 402 process involves determining what the conversation was about and understanding the intent of the user, as well as determining the flow/process followed by the contact center agents to address the intent. The flow mining output 408 may include a set of guided flows generated by the flow mining 402 process, an intent hierarchy (e.g., similar to the intent hierarchy of FIG. 8), a compliance checklist, a set of frequently asked questions (FAQs) and answers, and/or other relevant data. As described herein, the guided flows may outline the steps taken by the contact center agent to address various intents. The editor 410 may allow an administrator to modify the guided flows output by the flow mining 402 process. In doing so, in some embodiments, one or more new scripts 412 (or modifications to existing scripts) may be provided to the editor 410. It should be appreciated that the guided flows (in original form or post-modification by the editor 410) may be leveraged to generate one or more agent co-pilot scripts 414 that are used to configure an agent co-pilot 416 and/or one or more virtual agent scripts 418 that are used to configure a virtual agent 420.

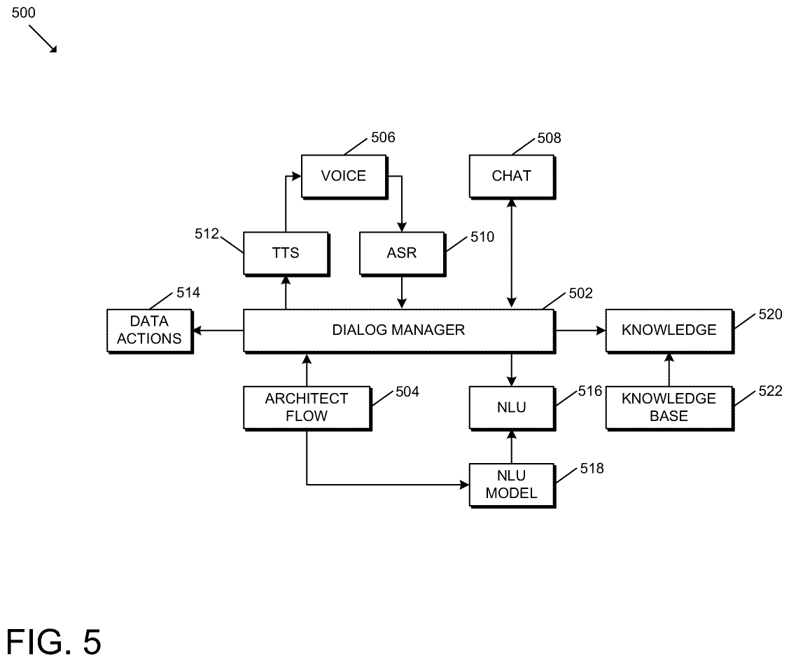

Referring now to FIG. 5, a chatbot architecture 500 for leveraging conversation flow mining may be executed by a computing system (e.g., the computing device 100, the contact center system 200, and/or other computing devices described herein). The illustrative dialog manager 502 is configured to map where the virtual/human agent is within the conversation and what needs to be done next (e.g., based on a guided flow received from the architect flow 504 system. More specifically, in some embodiments, a guided flow may be formatted into a rigid architect flow 504. It should be appreciated that the user may communicate with the contact center agent via voice 506 or chat 508. When communicating via voice 506, the user's audio may be captured and transcribed into text using an automated speech recognition (ASR) 510 system, and responses to the user may be converted from text to audio using the text-to-speech (TTS) 512 system. In some embodiments, the dialog manager 502 may execute one or more data actions 514, for example, by communicating with a backend system via a relevant application programming interface (API) to receive certain data (e.g., workforce management data). When input is received from the user, it is processed using the natural language understanding (NLU) 516 system, which leverages a NLU model 518. Further, in some embodiments, the dialog manager 502 may retrieve data (knowledge 520) from a knowledge base 522 relevant to addressing various intents.

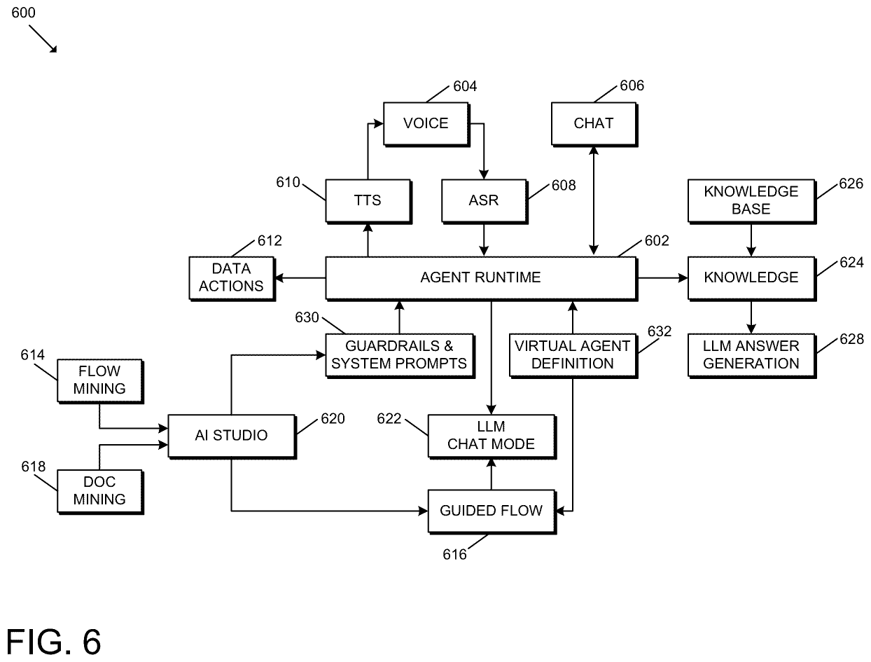

Referring now to FIG. 6, an LLM-based architecture 600 for leveraging conversation flow mining may be executed by a computing system (e.g., the computing device 100, the contact center system 200, and/or other computing devices described herein). The illustrative agent runtime system 602 may communicate with the user via voice 604 or chat 606. When communicating via voice 604, the user's audio may be captured and transcribed into text using an automated speech recognition (ASR) 608 system, and responses to the user may be converted from text to audio using the text-to-speech (TTS) 610 system. In some embodiments, the agent runtime system 602 may execute one or more data actions 612, for example, by communicating with a backend system via a relevant application programming interface (API) to receive certain data (e.g., workforce management data). The flow mining 614 system may be similar to the flow mining 402 system of FIG. 4 in that the flow mining 614 system performs flow mining on a set of transcripts of conversations between contact center agents and users as described herein to generate a set of guided flows 616 (e.g., skill-specific guided flows). The flow mining may also include document mining 618 as described herein. The artificial intelligence (AI) studio 620 may be similar to the editor 410 of FIG. 4 in that the AI studio 620 may allow an administrator to modify the guided flows output by the flow mining 614 system.

The illustrative agent runtime system 602 is configured to invoke a large language model (LLM) to have a conversation therewith, for example, using an LLM chat mode 622. For example, the agent runtime system 602 may retrieve data (knowledge 624) from a knowledge base 626 and/or through conversations with the large language model via the LLM answer generation system 628 in order to address user intents/queries. It should be appreciated that the large language model may be initialized/primes using a set of guardrails and prompts 630 as well as (or including) the guided flow(s) 616 (e.g., in order to reduce or eliminate hallucinations). Additionally, the agent runtime system 602 may further prime the large language model and/or execute various functions based on a virtual agent definition 632 that describes the virtual agent (e.g., the virtual agent is a helpful assistant for the healthcare industry).

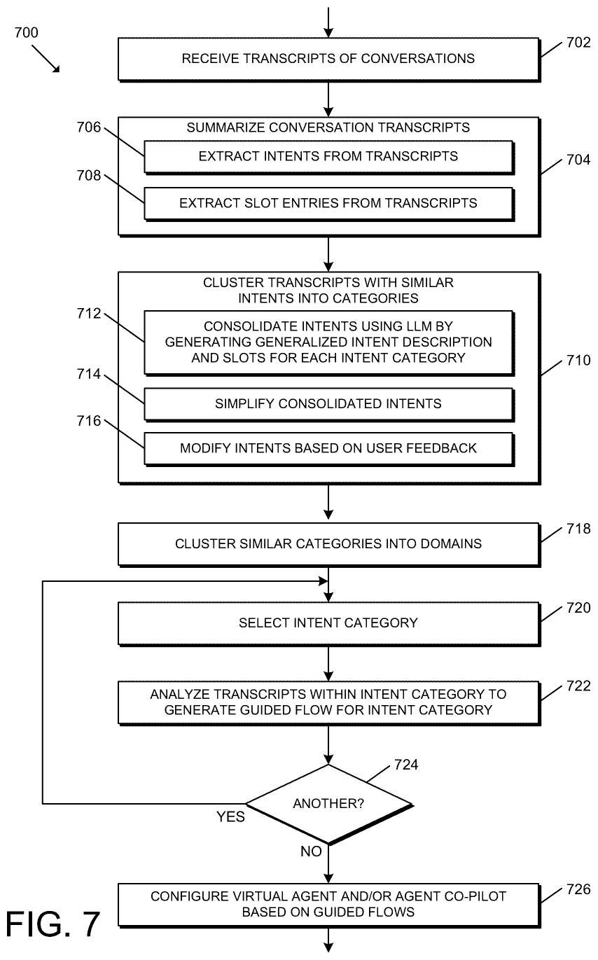

Referring now to FIG. 7, in use, a computing system (e.g., the computing device 100, the contact center system 200, and/or other computing devices described herein) may execute a method 700 for mining conversation flows. It should be appreciated that the particular blocks of the method 700 are illustrated by way of example, and such blocks may be combined or divided, added or removed, and/or reordered in whole or in part depending on the particular embodiment, unless stated to the contrary.

The illustrative method 700 begins with block 702 in which the computing system receives transcripts of conversations between contact center agents and users. In block 704, the computing system generates a system of each transcript. More specifically, in block 706, the computing system may extract one or more intents from (or associated with) each of the transcripts and, in block 708, the computing system may extract one or more slot entries from (or associated with) each of the transcripts. In some embodiments, it should be appreciated that the computing system may leverage a large language model to generate the summary of each transcript (e.g., a lightweight LLM).

In block 710, the computing system clusters the transcripts into a set of intent categories based on the respective summary of each transcript, such that similar intents are grouped with one another in the same category. For example, in some embodiments, the computing system leverages k-means clustering and/or another suitable clustering algorithm. It should be appreciated that the computing system may utilize any suitable technology and/or algorithm for determining how similar two intents are to one another. For example, in various embodiments, the computing system may leverage a similarity matrix, Euclidean distance, Mahalanobis distance, and/or other numerical measurement to determine the similarity of the data to one another. By way of example, the clustering may generate a set of clusters/categories centered or otherwise situated about a centroid, medoid, or other representative point with data points (e.g., intents) being associated with a particular cluster/category based on the “nearest” cluster/category.

In particular, in block 712, the computing system may consolidate similar intents using a large language model by generating generalized intent descriptions and slots for each intent category. It should be appreciated that the large language model used for consolidating intents may differ from the large language model used for summarization in some embodiments. In block 714, the computing system may further simplify the consolidated intents. For example, in some embodiments, the intent categories may overlap with one another, in which case the computing system may reduce the number of intent categories to reduce or eliminate any overlap. In block 716, the computing system may further modify the consolidated intents based on user feedback, for example, further reducing the number and/or description of the intent categories.

In block 718, the computing system may cluster similar intent categories into domains. For example, as depicted in the exemplary intent hierarchy of FIG. 8, the intents may be grouped into categories, and those categories may be grouped into domains.

In block 720, the computing system selects one of the intent categories and, in block 722, the computing system analyzes each transcript within the selected intent category to generate a guided flow for that intent category. As described above, the guided flow defines a set of actions to be taken by a contact center to resolve an intent associated with the selected intent category. In block 724, the computing system determines whether any other intent categories exist to be analyzed for generation of a corresponding guided flow. If so, the method 700 returns to block 720 in which the computing system selects another intent category for analysis. Otherwise, the method 700 advances to block 726 in which the computing system configures a virtual agent and/or agent co-pilot based on the generated guided flows.

Although the blocks 702-726 are described in a relatively serial manner, it should be appreciated that various blocks of the method 700 may be performed in parallel in some embodiments.

What is claimed is:

1. A method for mining conversation flows, the method comprising:
receiving, by a computing system, a plurality of transcripts of conversations between contact center agents and users;
generating, by the computing system, a summary of each transcript of the plurality of transcripts by extracting, for each transcript of the plurality of transcripts, one or more intents associated with the respective transcript and one or more slot entries associated with the respective transcript;
clustering, by the computing system, the plurality of transcripts into a plurality of intent categories based on the respective summary of each transcript of the plurality of transcripts, wherein each intent category of the plurality of intent categories includes intents that are similar to one another; and
analyzing, by the computing system, each transcript within a selected intent category of the plurality of intent categories to generate a guided flow for the selected intent category, wherein the guided flow defines a set of actions to be taken by a contact center agent to resolve an intent associated with the selected intent category.

2. The method of claim 1, further comprising configuring, by the computing system, a virtual agent based on the generated guided flow.

3. The method of claim 1, further comprising analyzing, by the computing system and for each intent category of the plurality of intent categories, each transcript within the respective intent category to generate a guided flow for the respective intent category, wherein the guided flow defines a set of actions to be taken by a contact center agent to resolve intents associated with the respective intent category.

4. The method of claim 3, further comprising configuring, by the computing system, a virtual agent based on guided flows generated for the respective intent categories.

5. The method of claim 1, wherein generating the summary of each transcript of the plurality of transcripts comprises generating the summary of each transcript of the plurality of transcripts using a first large language model.

6. The method of claim 5, wherein clustering the plurality of transcripts into the plurality of intent categories comprises consolidating similar intents using a second large language model.

7. The method of claim 6, wherein the first large language model is different from the second large language model.

8. The method of claim 6, wherein clustering the plurality of transcripts into the plurality of intent categories comprises generating a generalized intent description and slots for each intent category of the plurality of intent categories.

9. The method of claim 8, wherein clustering the plurality of transcripts into the plurality of intent categories comprises modifying the consolidated intents based on user feedback.

10. The method of claim 1, further comprising clustering the plurality of intent categories into a plurality of domains, wherein each domain of the plurality of domains includes intent categories that are similar to one another.

11. A computing system for mining conversation flows, the system comprising:
at least one processor; and
at least one memory comprising a plurality of instructions stored therein that, in response to execution by the at least one processor, causes the computing system to:
receive a plurality of transcripts of conversations between contact center agents and users;
generate a summary of each transcript of the plurality of transcripts by extracting, for each transcript of the plurality of transcripts, one or more intents associated with the respective transcript and one or more slot entries associated with the respective transcript;
cluster the plurality of transcripts into a plurality of intent categories based on the respective summary of each transcript of the plurality of transcripts, wherein each intent category of the plurality of intent categories includes intents that are similar to one another; and
analyze each transcript within a selected intent category of the plurality of intent categories to generate a guided flow for the selected intent category, wherein the guided flow defines a set of actions to be taken by a contact center agent to resolve an intent associated with the selected intent category.

12. The computing system of claim 11, wherein the plurality of instructions further causes the computing system to configure a virtual agent based on the generated guided flow.

13. The computing system of claim 11, wherein the plurality of instructions further causes the computing system to analyze, for each intent category of the plurality of intent categories, each transcript within the respective intent category to generate a guided flow for the respective intent category, wherein the guided flow defines a set of actions to be taken by a contact center agent to resolve intents associated with the respective intent category.

14. The computing system of claim 13, wherein the plurality of instructions further causes the computing system to configure a virtual agent based on guided flows generated for the respective intent categories.

15. The computing system of claim 11, wherein to generate the summary of each transcript of the plurality of transcripts comprises to generate the summary of each transcript of the plurality of transcripts using a first large language model.

16. The computing system of claim 15, wherein to cluster the plurality of transcripts into the plurality of intent categories comprises to consolidate similar intents using a second large language model.

17. The computing system of claim 16, wherein the first large language model is different from the second large language model.

18. The computing system of claim 16, wherein to cluster the plurality of transcripts into the plurality of intent categories comprises to generate a generalized intent description and slots for each intent category of the plurality of intent categories.

19. The computing system of claim 18, wherein to cluster the plurality of transcripts into the plurality of intent categories comprises to modify the consolidated intents based on user feedback.

20. The computing system of claim 11, wherein the plurality of instructions further causes the computing system to cluster the plurality of intent categories into a plurality of domains, wherein each domain of the plurality of domains includes intent categories that are similar to one another.
